(19) United States
(12) Patent Application Publication
(10) Pub. No.: US 2015/0173339 A1
(43) Pub. Date: Jun. 25, 2015

(54) Combination Insect Trap and Furniture Moving Apparatus

(71) Applicants: Gerrett Stier, Fort Wayne, IN (US); Larry Dauscher, Fort Wayne, IN (US)

(72) Inventors: Gerrett Stier, Fort Wayne, IN (US); Larry Dauscher, Fort Wayne, IN (US)

(21) Appl. No.: 14/638,358

(22) Filed: Mar. 4, 2015

(51) Int. Cl. A01M 1/10

(52) U.S. Cl. CPC A01M 1/103

(57) ABSTRACT

A combination insect trap and furniture moving apparatus, said apparatus comprising: an exterior wall, said exterior wall having an angled leading side, an upper plateau, and a vertical trailing side; an interior wall, said interior wall having a vertical leading side, an upper plateau, and an vertical trailing side; a channel, said channel disposed between said vertical trailing side of said exterior wall and said vertical leading side of said interior wall; said exterior wall further comprises a height relative to said channel; said interior wall further comprises a height relative to said channel; and said height of said interior wall is greater than said height of said exterior wall.

### BACKGROUND

1. Field of the Art

The present invention relates generally to pest control devices and furniture sliding devices. More specifically, the present invention relates to a combination non-chemical pest control and furniture slide device.

2. Description of the Prior Art

Many devices and methods exist to eliminate pests, including non-flying insects such as bed bugs, a flat, oval, non-flying insect that may be commonly mistaken for a tick or a small cockroaches. Bed bugs feast on human and animal blood, sucking the blood usually at night. They release a chemical as they bite through skin to numb the flesh. Humans may not know when they are being bitten. Bed bugs typically live in mattresses, bedding, headboards, bed frames and springs, couches, and other furniture, laying lots of tiny eggs and increasing the population extremely fast when source of blood is available. Hotels, apartment buildings, condominiums, and resorts are generally at an extremely high risk of bed bug infestation.

Modern extermination methods typically require using heat (steam and a washer/dryer) and/or freezing cold, plus a variety of insecticides.

In a typical treatment, homeowners or tenants are required to launder all clothing, bedding, and draperies; put all possessions in drawers and closets inside sealable bags or containers; move large furniture away from walls; vacuum and clean the rooms on treatment days; and vacate the premises. The company hired to treat the building must treat all baseboards, picture frames, bed frames, dressers, drawers, and tables. Usually there is no guarantee to eliminate every bed bug in the room after the first treatment and multiple visits of professional services may be needed. Thus, a need exists to provide a simple bed bug trap that allows for a visual indication of treatment success while preventing any bed bugs from reacting to food source such as a person in bed or on a sofa.

Additionally, the above described treatment typically requires that the pest control company personnel spend significant time and energy moving furniture during treatment. Thus, another need exists for a bed bug device that also allows for easier furniture moving. In the moving industry and in the carpet cleaning industry, it is quite usual to face the situation of having to move large, heavy and sometimes awkwardly shaped furniture within the confines of buildings. The most common method used for moving heavy objects is for the movers or cleaners to pick the object up and carry it by hand, but this is not always a feasible or preferable arrangement. With the exception of moving furniture up and down stairways, or a special orientation of heavy or awkwardly shaped furniture which requires lifting, it has been found that placing a separate one piece slide under the object to be moved and over the surface to which it is being moved, is beneficial so that the article may be slid across the horizontal surfaces which it must traverse in order to be relocated or moved within the confines of the building.

The prior art devices, however, do not take into consideration all of the objects of the present invention. Specifically, the prior art fails to disclose, teach, or suggest an apparatus that provides a mechanical bed bug trap and furniture moving device.

U.S. Pat. No. 5,984,360 discloses a furniture slide for placement between an object to be moved and the flooring over which it is to be moved. The slide is formed of an elongate sheet of flexible material having opposing ends and side walls joining said opposing ends when viewed in plan. The sheet has opposing faces when viewed in side with one of the faces for abutting support and sliding contact with a floor surface and the other face having a compressible material fixed thereon for an abutting support contact with an object to be moved. A hole and grommet are formed on one or both ends of the sheet of material for applying force for movement of the slide. Preferably, the ends of the slide are substantially arcuate in configuration from side wall to side wall. The sheet of material preferably comprises a plastic material, preferably high density polyethylene material, and said compressible material comprises a rubber material. The invention further discloses a method of moving furniture which comprises placing a sheet of material having a reduced friction surface and a friction engaging surface between a portion of the furniture to be moved and the floor over which it will be moved, with the frictional surface engaging the furniture and the reduced friction surface engaging the floor. A second sheet of the same material is then placed under a second portion of the furniture. Force is then applied to the sheet of material to move the furniture.

U.S. Pat. No. 6,206,424 discloses a furniture slide for moving furniture over a floor surface and also serving to provide foam drying blocks under the furniture for placement on wet carpet surfaces. The furniture slide of the present invention includes a sheet of material having a convex bottom base for sliding on a floor surface and further includes compressible material that is adhered to the top face of the sheet for support contact with the furniture to be moved. This compressible material is precut whereby a plug of the compressible material may be readily removed therefrom to provide a cavity in the compressible material. Then a slightly thicker Styrofoam drying block, which is dimensioned for insertion into this cavity, is inserted into the cavity. The drying block has an upper surface with a sticky adhesive so that the drying block sticks and remains adhered to the supported furniture when the remainder of the furniture slide is removed. The slide sheet is further provided with an upturned perimeter edge.

U.S. Pat. No. 6,464,256 discloses a furniture slide for placement between an object to be moved and flooring over which it is to be moved, which includes a sheet of flexible material having top and bottom faces and complex curvature on the bottom face with a concave curvature along the longitudinal axis thereof and a convex curvature along the transverse axis thereof. A compressible material is adhered to the top face for support contact with an object to be moved.

U.S. Pat. No. 8,146,290 for bedbugs, in the form of a double-ply pouch having its periphery sealed to create a compartment for containing an attractant. A slit opening is made in the top layer and a tubular funnel-shaped member is inserted in the slit opening to create an access opening for the bedbugs to enter into the sealed compartment.

U.S. Pat. No. 8,316,578 discloses a device for attracting and capturing an insect. The device includes a housing which defines an interior space and a plurality of entrances in open communication with the interior space, a downwardly sloping panel coupled to and disposed within the housing, and an adhesive attached to at least a portion of the bottom surface of the downwardly sloping panel. The downwardly sloping panel and the housing together define a tapering passageway which leads to a crevice opposite at least one of the plurality of entrances, and the adhesive attached to the bottom surface of the panel is adapted to capture the insect.

U.S. Pat. No. 8,402,690 discloses a bedbug trap having a base with an outer wall that may be formed as an angled ramp having a relatively shallow angle that leads to an entryway, and an inner wall extending from the outer wall that may be formed as an angled chute having a relatively steep angle. The ramp may be textured or otherwise skid-resistant, and the chute is smooth. A catch container attaches underneath the base and has a floor spaced away from the chute. A source of attractant, for example, an insulated container containing dry ice, rests on the base such that at least a portion of attractant from the container will flow toward the top of the ramp. A cover may attach to the base, enclosing the insulated container.

U.S. Pat. No. 8,413,370 discloses a bedbug trap having at least a first plane panel of fibrous material and a second panel of fibrous material, the first panel having a zone covered in an adhesive for fastening to the second panel, the second panel including a strip of adhesive on at least one face, which adhesive strip is of a width that is less than the width of the first panel, and the first panel including a zone that is covered in an adhesive that is located at a distance from and facing the adhesive strip, wherein the second panel is plane, and the first and second panels are made of respective first and second portions of a single initial plane panel of fibrous material that is previously coated in adhesive and then folded in half so that the first portion and the second portion face each other, the adhesive strip extending over the second portion of the initial panel, being prolonged over the first portion of the initial panel, the fastening zone between the first and second portions of the initial panel being implemented by adhesive spots placed on the initial panel and of thickness greater than the thickness of the prolonged adhesive strip, thereby forming channels.

U.S. Pat. No. 8,635,807 discloses a bed bug monitor having a base and a central housing. The central housing is insulated and encloses a supply of solid carbon dioxide. During use, an aperture in the housing releases a plume of carbon dioxide vapor which attracts bed bugs onto the base.

U.S. Pat. No. 8,707,615 discloses a segmented, floor-based trap system, which may be configured to delineate a floor area of arbitrary rectilinear geometry that is infested with crawling arthropods, particularly bed bugs, or an area to be protected from such infestation, thereby to intercept egress of such insects from such an area, or their ingress into it. The trap system comprises a plurality of trough-like linear segments containing a layer of mechanical insecticide, such as diatomaceous earth, and serving as an insect pitfall, and a plurality of linear and right-angled connectors, by which the linear segments may be connected continuously in fluid communication. A roughened, obtusely inclined flange extends from the top of each of the side walls of each linear segment to the floor, serving as a ramp leading insects to the smooth-walled pitfall. Foreshortened linear segments fitted to corner connectors in concave corners of the trap assembly preserve rectilinear alignment.

Thus, as shown herein, the known prior art fails to disclose, teach, or suggest a combination mechanical bed bug trap and furniture moving apparatus.

### SUMMARY

The present invention includes a combination insect trap and furniture moving apparatus, comprising: an exterior wall, said exterior wall having an angled leading side, an upper plateau, and a vertical trailing side; an interior wall, said interior wall having a vertical leading side, an upper plateau, and an vertical trailing side; a channel, said channel disposed between said vertical trailing side of said exterior wall and said vertical leading side of said interior wall; said exterior wall further comprises a height relative to said channel; said interior wall further comprises a height relative to said channel; and said height of said interior wall is greater than said height of said exterior wall.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 shows: a top view of an apparatus according to an exemplary ebodiment of the present invention.

FIG. 2 shows: a top perspective view of the apparatus of FIG. 1.

FIG. 3 shows: a side view of the apparatus of FIG. 1.

FIG. 4 shows: a bottom view of the apparatus of FIG. 1.

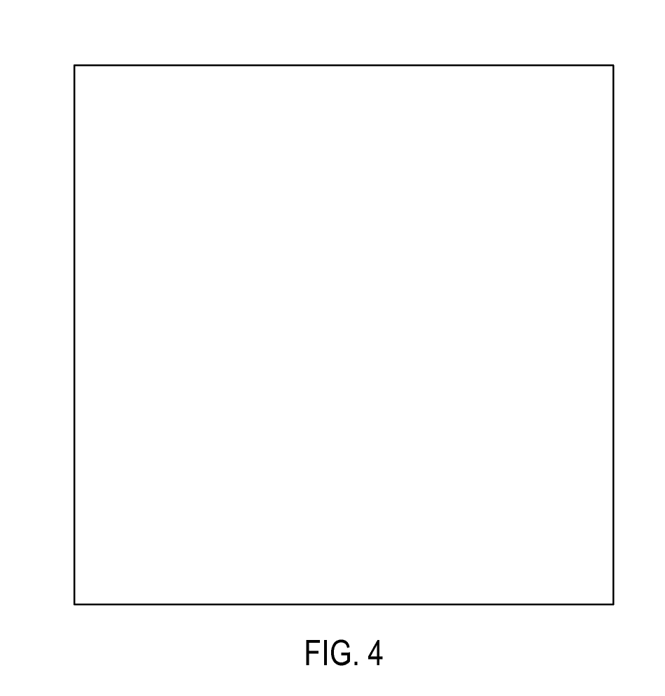

### DETAILED DESCRIPTION OF THE EMBODIMENTS

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

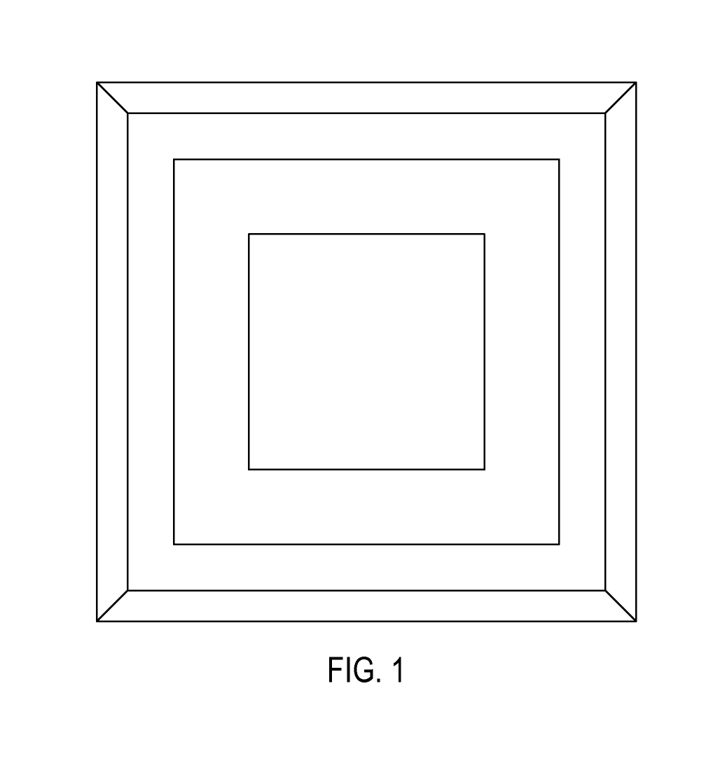

Thus, all of the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring first to FIG. 1, there is shown a top view of an apparatus according to an exemplary embodiment of the present invention. As illustrated in the FIG. 1, combination inset trap and furniture moving apparatus 1000 generally comprises a top insect trap 500. Insect trap 500 comprises a top insect trap 500 having generally cuboid shape, exterior wall 30, an interior wall 100, and a channel 40 disposed there between. Inset trap 500 of combination insect trap and moving apparatus 1000 further comprises interior cavity 80 disposed within interior wall 100.

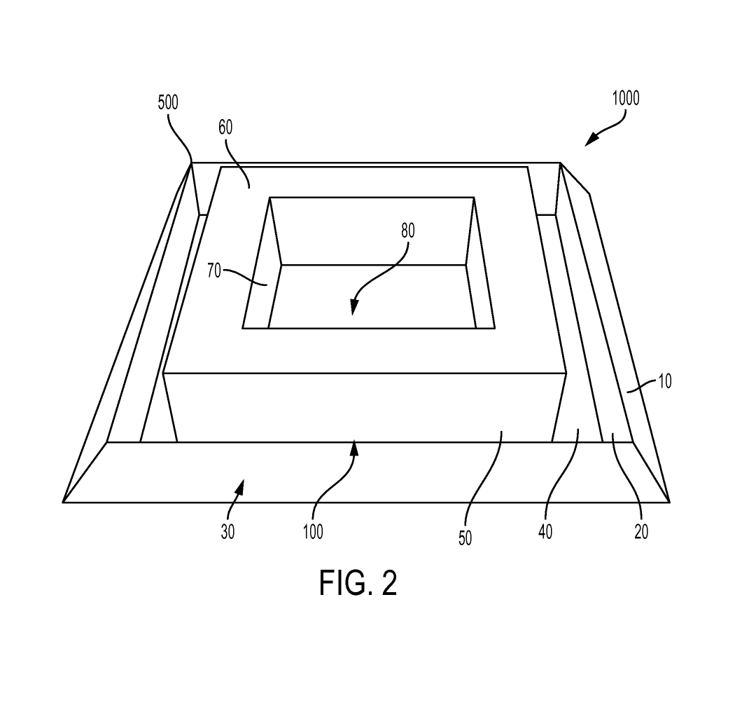

Referring now to FIG. 2, there is shown a top perspective view of combination insect trap and furniture moving apparatus 1000. As shown in FIG. 2, insect trap 500 of apparatus 1000 comprises exterior wall 30. Exterior wall 30 comprises leading side 10. Preferably, leading side 10 of exterior wall 30 comprises an angle within a range of from about 15 degrees to about 20 degrees. Leading wall 10 comes to a peak or a plateau at which it meets with trailing side 20 of exterior wall 30. Trailing side 20 of exterior wall 30 preferably has a much steeper incline than leading side 10 of exterior wall 30. In the preferred embodiment of the present invention, trailing wall 20 of exterior wall 30 is completely vertical. Leading side 10 of exterior wall 30 may further comprise a roughened, or otherwise generally higher friction surface, than trailing wall 20 of exterior wall 30. Exterior wall 30 further comprises a height measured from channel 40. Preferably, the height of wall 30 is within range from about 0.5 to about 2 cm.

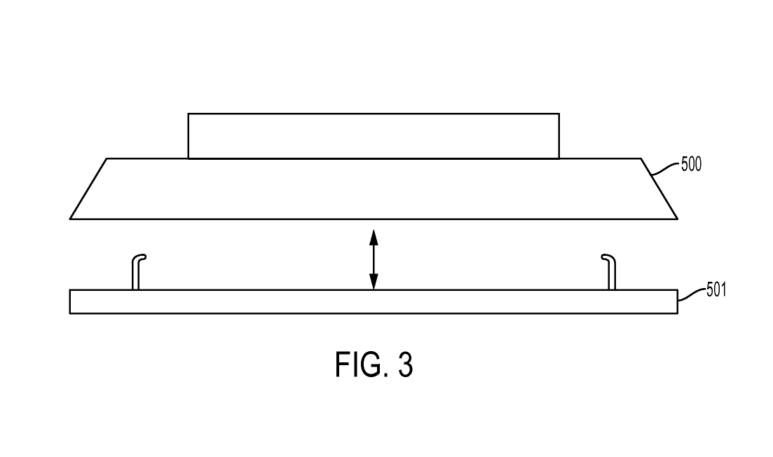

Referring generally to FIGS. 1 and FIG. 2, insect trap 500 of apparatus 1000, according to the present invention, further comprises interior wall 100. As illustrated in FIG. 1 and FIG. 2, interior wall 100 preferably comprises leading side 50, plateau side 60, and trailing side 70. Interior wall 100 also comprises a height as measured above channel 40. Interior wall 100 has a height as measured from channel 40 of within a range from about 0.5 to about 2 cm. As further illustrated in FIG. 2 and FIG. 3, the height of interior wall 100 is greater than the height of exterior wall 30.

Referring again to FIG. 1 and FIG. 2, and as described above, interior wall 100 further comprises plateau 60 disposed at the top and in between leading side 50 and trailing side 70 of interior wall 100. Preferably plateau 60 of interior wall 100 has a width of at least about 1.0 cm. Those of skill in the art will appreciate that the present invention can be designed such that interior wall 100 comprises a cuboid with no cavity whatsoever. However, the preferred embodiment of combination inset trap and furniture moving apparatus 1000 further comprises cavity 80 as illustrated in FIG. 2.

Cavity 80 may comprise any convenient area to simplify manufacturing or to reduce manufacturing costs. However, cavity 80 is preferably suitably sized to receive a standard wheel or caster for heavy furniture. Cavity 80 may further comprise sloped slots 81 and 82 disposed to facilitate placement of said casters into cavity 80.

Combination inset trap and furniture moving apparatus 1000 of the present invention is designed to be structurally sound while bearing the weight or a portion of the weight of individual furniture pieces such as bedframes, sofas, chairs, tables, recliners and the like. Thus, it is preferred that combination inset trap and furniture moving apparatus 1000 comprises a structurally sound material for this purpose such as hard rubber, a hard thermoplastic, a hard thermoset palmer, or other lightweight material suitable for weight bearing purposes including aluminum.

Referring now to FIG. 3, combination inset trap and furniture moving apparatus 1000 of the present invention comprises insect trap 500 and furniture sliding attachment 501 which is affixable to the bottom of trap 500. As illustrated in FIG. 3, sliding attachment 501 generally comprises a bottom face which may be a separate snap-fit or otherwise attached piece having a smooth or arcuated surface for sliding on a carpeted floor. Those of skill in the art will appreciate that alternative embodiments of slidable surfaces may also be used with the present invention.

Those who are skilled in the art will appreciate that although the present invention preferably comprises a generally cuboid shape as shown in FIG. 1, alternative exemplary embodiments of the present invention exist. For example the shape may be circular, ovoid, or triangular.

The above-described embodiments are merely exemplary illustrations set forth for a clear understanding of the principles of the invention. Many variations, combinations, modifications, or equivalents may be substituted for elements thereof without departing from the scope of the invention. It should be understood, therefore, that the above description is of an exemplary embodiment of the invention and included for illustrative purposes only. The description of the exemplary embodiment is not meant to be limiting of the invention. A person of ordinary skill in the field of the invention or the relevant technical art will understand that variations of the invention are included within the scope of the claims.

1. A combination insect trap and furniture moving apparatus, said apparatus comprising: an exterior wall, said exterior wall having an angled leading side and a vertical trailing side; an interior wall, said interior wall having a vertical leading side, and an vertical trailing side; a channel, said channel disposed between said vertical trailing side of said exterior wall and said vertical leading side of said interior wall; said exterior wall further comprises a height relative to said channel; said interior wall further comprises a height relative to said channel, where said height of said interior wall is greater than said height of said exterior wall.

2. The apparatus of claim 1, further comprising a plateau between said exterior wall lending side and said exterior wall trailing side.

3. The apparatus of claim 1, further comprising a plateau between said vertical leading side of said exterior wall and said vertical trailing side of said interior wall.

4. The apparatus of claim 1, further comprising first plateau between said vertical leading side of said exterior wall and said vertical trailing side of said interior wall and a second plateau between said exterior wall leading side and said exterior wall trailing side.

5. The apparatus of claim 1, further comprising wherein said leading side of said exterior wall is disposed at an angle within a range of from about 15° to about 60°.

6. The apparatus of claim 1, wherein the difference in height between said exterior wall and said interior wall is within a range of from about 0.5 to about 1.5 cm.

7. The apparatus of claim 1, wherein the apparatus comprises a generally cuboid shape.

8. The apparatus of claim 1, wherein the apparatus comprises a generally cuboid shape.

9. The apparatus of claim 1, wherein the apparatus comprises a generally extruded triangle shape.

10. The apparatus of claim, wherein the apparatus comprises a material selected from the group consisting of thermoplastic polymer; thermoset polymer; and composite material.

11. The apparatus of claim 1, wherein said plateau has an average width within a range of from about 0.5 cm to about 1.5 cm.

12. The apparatus of claim 3, wherein said plateau has an average width within a range of from about 1.5 cm to about 2 cm.

13. The apparatus of claim 4, wherein the apparatus further comprises a cavity disposed wherein said interior wall.
